(19) United States
(12) Patent Application Publication
(10) Pub. No.: US 2008/0084035 A1
(43) Pub. Date: Apr. 10, 2008

(54) Cart with caster lift

(76) Inventors: Christopher M. Johnson, Richmond, VA (US); Terril Porter, Richmond, VA (US); Ralph McCann, Richmond, VA (US)

Correspondence Address: MCGUIREWOODS, LLP, 1750 TYSONS BLVD, SUITE 1800, MCLEAN, VA, 22102, US

(21) Appl. No.: 11/586,725

(22) Filed: Oct. 26, 2006

Related U.S. Application Data
(60) Provisional application No. 60/730,360, filed on Oct. 27, 2005.

(51) Int. Cl. B62B 5/00

(52) U.S. Cl. 280/33.997

(57) ABSTRACT

A shopping cart includes front and rear casters, a frame supported by the front and rear casters, a tray attached to the frame and a lifting structure arranged on the tray and configured to elevate rear casters of a preceding cart upon engaging thereto. The lifting structure includes a first portion configured to elevate the rear casters of the preceding cart upon engaging thereto, a second portion adjoining the first portion and maintaining the rear casters of the preceding cart elevated upon engaging thereto, and a third portion located between the first portion and the second portion and configured to resist the preceding cart from sliding off the shopping cart.

### CROSS-REFERENCE TO RELATED APPLICATIONS

This application claims priority under 35 U.S.C. §119(e) to provisional U.S. Patent Application No. 60/730,360, filed on Oct. 27, 2005, the disclosure of which is expressly incorporated by reference herein in its entirety.

### BACKGROUND OF THE INVENTION

1. Field of the Invention

The invention is directed to carts, particularly to shopping carts with a structure for reducing damage to casters and improving lateral maneuverability during the transportation thereof.

2. Related Art

Shopping carts generally include four sets of casters with two casters in the front and two casters in the rear of the cart. Typically, the two front casters are configured to rotate about a vertical axis whereas the rear set of casters are configured not to rotate about the vertical axis. Such an arrangement does not cause any problems for individual shoppers. However, when multiple shopping carts are nested together and transported from one particular area to another particular area, such as a parking lot area to the front of the store, then the non-swiveling rear casters may be damaged during such transportation. In particular, during the process of transporting the carts, there will tend to be a need to steer the carts to change direction of the line of nested carts. This steering movement may not cause any significant problems for the front casters that are able to swivel, but the rear casters will have to slide or be dragged across the ground, in order to achieve the steering movement. In this regard, this lateral dragging of the rear casters will cause the rear casters and/or the cart to be damaged. Moreover, the need for dragging the rear casters reduces maneuverability of the shopping carts.

Accordingly, there is a need for reducing damage to the rear casters of the cart and for increasing lateral maneuverability during the transportation thereof.

### SUMMARY OF THE INVENTION

The invention meets the foregoing needs and provides a method and apparatus that lifts the rear casters of a shopping cart to avoid or reduce damage caused by at least lateral movement of the shopping cart and increases maneuverability while limiting stress to the shopping cart and that furthermore includes other advantages apparent from the discussion herein.

Accordingly, in one aspect of the invention a shopping cart includes front and rear casters, a frame supported by the front and rear casters, a tray attached to the frame, and a lifting structure arranged on the tray and configured to elevate rear casters of a preceding cart upon engaging thereto. The lifting structure may include the first portion configured to elevate the rear casters of the preceding cart upon engaging thereto, the second portion adjoining the first portion and maintaining the rear casters of the preceding cart to be elevated upon engaging thereto, and the third portion located between the first portion and the second portion and configured to resist the preceding cart from sliding off from the shopping cart.

According to another aspect of the invention, a lifting structure for a shopping cart includes a ramp portion arranged on an upper surface of the lifting structure configured to elevate rear casters of a preceding cart upon engaging thereto, a lift portion arranged on the upper surface of the lifting structure configured to maintain the rear casters of the preceding cart to be elevated upon engaging thereto, and a lip portion arranged between the ramp portion and the lift portion on the upper surface the lifting structure and configured to resist the preceding cart from sliding off from the shopping cart.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 illustrates a shopping cart with a lifting structure, constructed according to the principles of the invention;

FIG. 2 shows details of the tray of the shopping cart shown in FIG. 1;

FIG. 3 shows details of an exemplary lifting device arranged on the tray of FIG. 1;

FIG. 4 shows a side view of the shopping cart shown in FIG. 1;

FIG. 5 shows a side view of two shopping carts nested together according to the principles of the invention;

FIG. 6 shows a perspective view of the trays of the two shopping carts shown in FIG. 5 nested together;

FIG. 7 shows three shopping carts nested together according to the principles of the invention;

FIG. 8 shows a bottom view of the lifting structure shown in FIG. 3 constructed according to the principles of the invention; and

FIG. 9 shows another embodiment of a lifting structure constructed according to the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

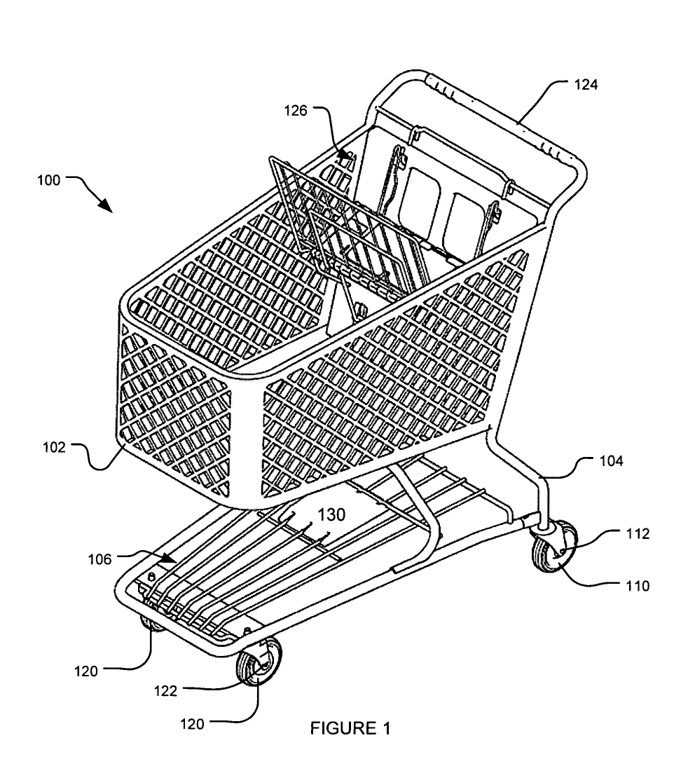

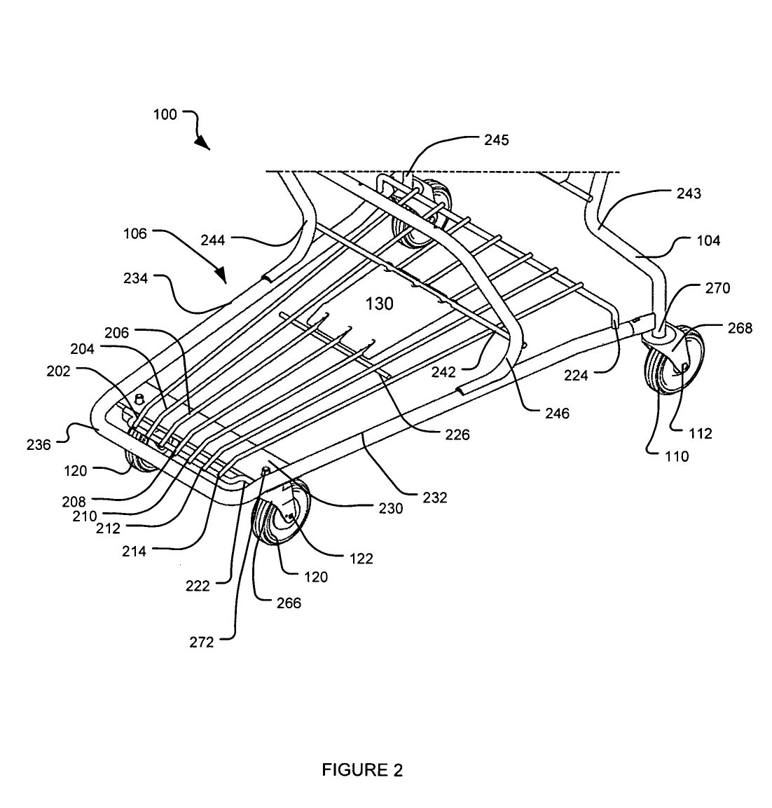

With reference to FIGS. 1 and 2, a cart 100, such as a shopping cart, may be constructed with components that are commonly used in conventional carts, such as a basket 102, a frame (e.g., chassis) 104, a tray 106, rear casters 110, front casters 120, and a handle 124. The basket 102 may be used to hold groceries or other items that a shopper might desire to purchase while shopping. The basket 102 of the cart 100 may be formed of a plastic material that is molded, may have a welded metallic construction that is painted or powder coated, or have any other known construction. The cart 100 may also include the handle 124 to guide the cart 100 through the shopping process and may also include an area 126 for small children to sit, mount a baby carrier, or load small or delicate items. The tray 106, which may be used to carry larger items or overflow items from the basket 102, may be positioned just above the casters 110, 120 and below the basket 102. The cart 100 also includes a lifting structure 130 described in detail below.

The cart 100 may include four casters: two front casters 120 and two rear casters 110 (only one shown in FIG. 1). Both the rear and front and casters 110,120 are configured to rotate around a horizontal axis such as axle 112, 122 (only two shown). The front casters may be configured to rotate, swivel or pivot about a vertical axis 272 (shown in FIG. 2). On the other hand, as mentioned above, the rear casters 110 may be configured not to rotate about a vertical axis, which may cause difficulty in transporting and steering a line of the carts nested together.

As shown in FIG. 2, the tray 106 may be formed of multiple longitudinal bars 202, 204, 206, 208, 210, 212, 214 extending between the front and rear ends of the tray, and cross bars 222, 226, 242, 224 traversing some or all of the longitudinal rods. The longitudinal bars 202, 204, 206, 208, 210, 212, 214 and cross bars 222, 226, 242, 224 may be formed of metal and may be bent to the desired shape and then spot welded together to form the tray 106. Subsequent to this construction of tray 106, the tray 106 may be chrome-plated, powder coated, or the like to prevent or reduce corrosion. It should be noted, however, that although a particular construction of the tray 106 is described herein, any type of tray material and/or configuration may be employed. In particular, it is contemplated that tray 106 may employ a molded plastic construction or any other known type of construction as long as the lifting structure 130 can be formed thereon or therein. Also, the tray 160 may be constructed to provide a light weight yet strong support structure that will allow a shopper to utilize the space above the casters 110, 120 and below the basket 102 and also function to be or to hold the lifting structure 130.

The frame 104 is constructed to provide sufficient support for the basket 102, the tray 106 and the handle 124. The frame 104 may include vertical uprights 243, 244, 245, 246, horizontal members 232, 234, 236, and may include other structure known to those in the art. The frame 104 is mounted on and supported by the front and rear casters 110, 120. The front casters 120 may be attached to the bottom surface of a front caster panel 230, which is attached to the horizontal members 232, 234 of the frame 104. The rear casters 110 may be attached to the bottom ends the vertical uprights 243, 245 of the frame 104. For example, an axle support 268 supporting the horizontal axle 112 of the rear caster 110 may be connected to frame 104 via a connector 270. No vertical axle may be provided to the rear casters 110 such that the rear casters 110 do not to swivel. Contrarily, the front casters 120 may be configured to swivel by pivotally connecting the axle support 266 supporting a horizontal axle 122 to the front caster panel 230 via a vertical axle 272.

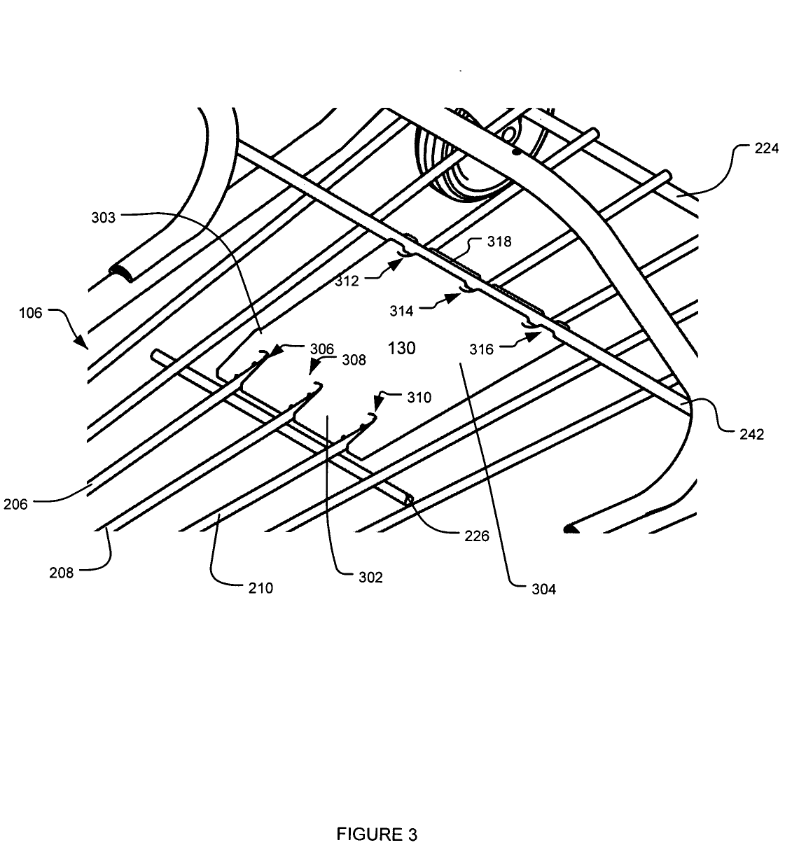

FIGS. 2 and 3 show an exemplary construction of the lifting structure 130 arranged on the tray 106. The lifting structure 130 may include a ramp area 302 at the front most of the tray 106. This ramp area 302 provides a smooth transition surface for engaging the cross rod 224 or any similar structure of a preceding cart. The lifting structure 130 may further include a flat area 304 that holds or retains the cross rod 224 of the preceding cart (not shown in FIGS. 2 and 3). The ramp area 302 and the flat area 304 are separated by a lip area 303 that is vertically higher than ramp area 302 and flat area 304 and thus resists the preceding cart from sliding off the flat area 304.

In operation, the shopping cart 100 is nested to the preceding cart. As the cross rod 224 of the preceding cart traverses the ramp area 302, the rear portion of the preceding cart is lifted, which results in lifting of the rear casters 110, 110 of the preceding cart from the ground. After traversing the ramp area 302, the cross rod 224 of the preceding cart may cross over the lip area 303 and be positioned on the flat area 304, which maintains the rear casters of the preceding cart off the ground. The preceding cart may be more or less locked or restrained on the flat 304 by the lip area 303.

The lifting structure 130 may be constructed integral to the tray 106, or the lifting structure 130 and the tray 106 may be manufactured separately, assembled together via engagement mechanism, or the like. FIG. 3 shows an exemplary lifting structure 130 attached to the longitudinal rods 206, 208, 210 and the cross bar 242. More specifically, the lifting structure 130 may include slots 306, 308, 310. These slots may engage to the longitudinal rods 206, 208, 210 respectively and provide the lifting structure 130 a tight engagement to the tray 106. Further, the lifting structure 130 may include rear slots 312, 314, 316 which may allow the lifting structure 130 to be inserted into the tray 106 between the rods 206, 208, 210 while in a vertical orientation and rotated such that slots 306, 308, 310 engaged to the rods 206, 208, 210. Further, a rear slot 318 may engage the cross rod 242. The engagement of the slots 306, 308, 310, 312, 314, 316 and the rear slot 318 with the longitudinal rods 206, 208, 210 and the cross rod 242 provides a secure attachment to the tray 106. It should be noted that the foregoing is merely an exemplary attachment configuration and that any known attachment is contemplated by the invention.

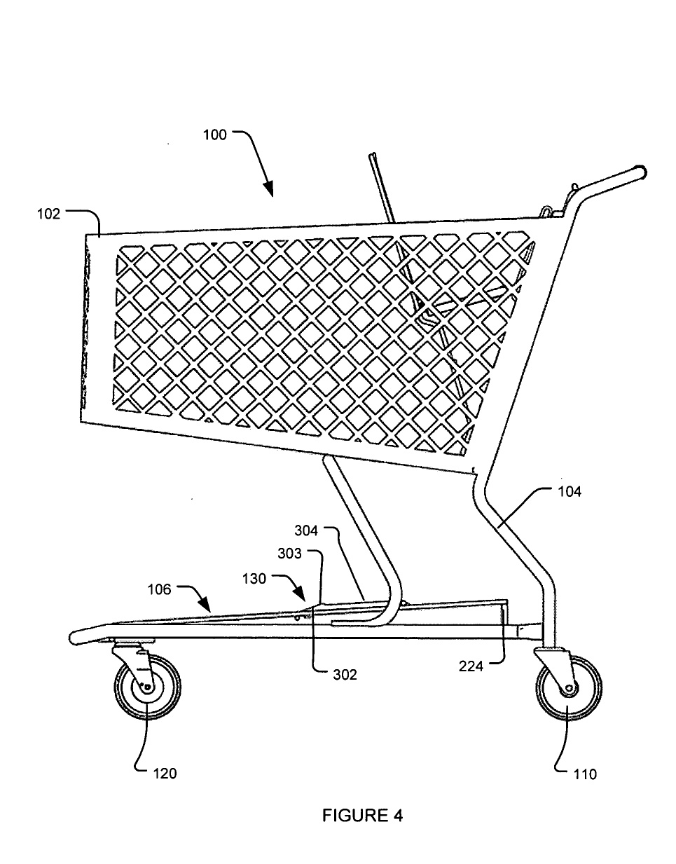

In FIG. 4, which shows a side view of the shopping cart 100, the lifting structure 130 is positioned about mid way along the tray 106. It should be apparent, however, that the lifting structure 130 may be positioned at any point along tray 106, as is contemplated in the invention. The lifting structure 130 provides a vertically higher upper surface than tray 106. Moreover, the lip 303 may be even higher than the lift surface 304 of the lifting structure 130. The tray 106 may be constructed to have a more flexible construction as compared with the frame 104. In this regard, positioning the lifting structure 130 on the tray 106 forms a flexible support for the lifting structure 130. Accordingly, when the weight on the lifting structure 130 becomes too great, the tray 106 may flex and the casters of the preceding carts that have been lifted by the lifting structure 130 may be lowered. This will reduce stress applied to the frame 104.

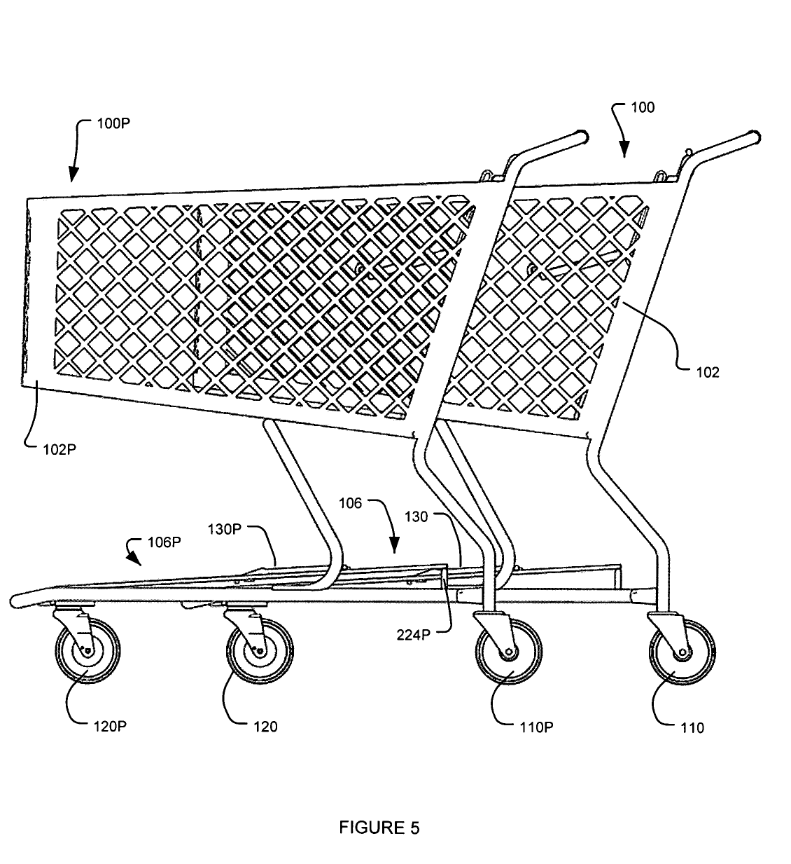

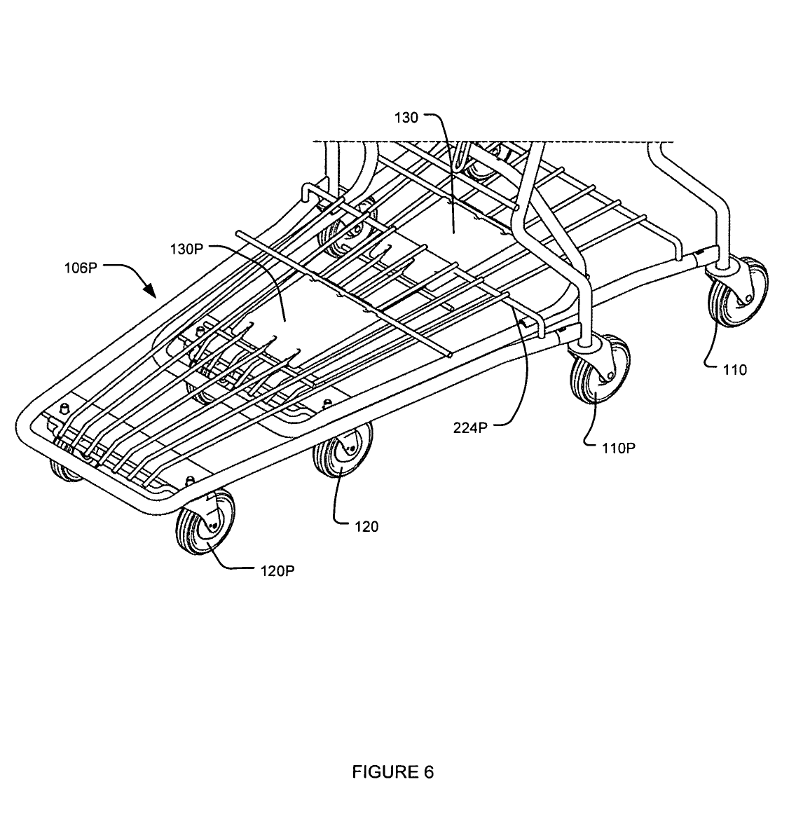

FIGS. 5 and 6 show the nesting operation of the shopping cart 100, together with a preceding shopping cart 100P, in which the tray 106 of the shopping cart 100 is concatenated with the tray 106P of the preceding cart 100P. The tray 106P, and more specifically the cross rod 224P of the preceding cart 100P may engage with the lifting structure 130 of the shopping cart 100. This engagement causes the rear casters 110P of the preceding cart 100P to be lifted off the ground or other rolling surface and be held elevated above the same. FIG. 6 shows in further perspective detail the operation of lifting structure 130 operating as described in FIG. 5 above.

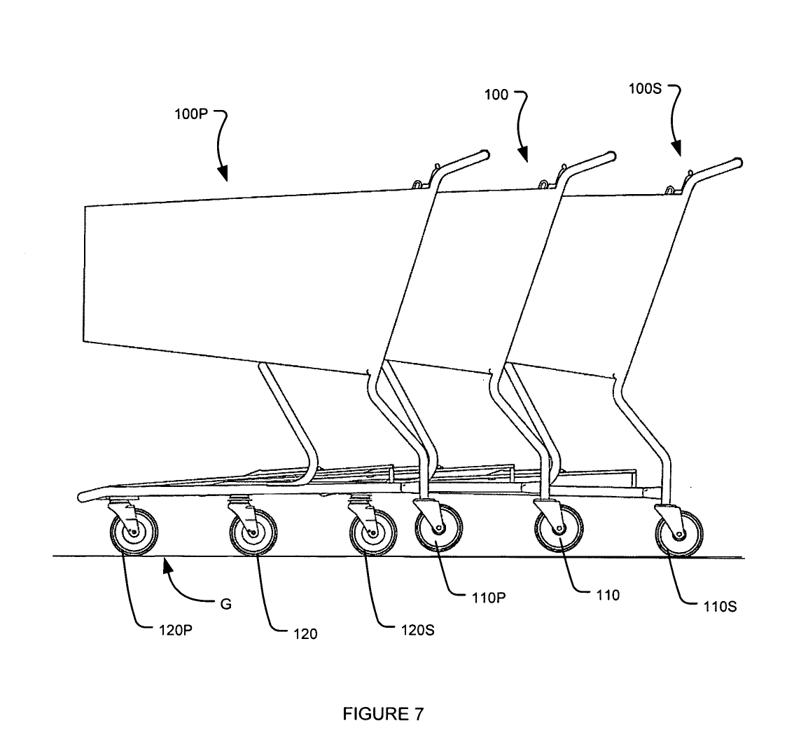

FIG. 7 shows a further operation of the lifting structure 130 of the invention in which a series of the shopping carts are nested together. In particular, the shopping cart 100 is inserted to a preceding cart 100P and a subsequent cart 100S is inserted to the shopping cart 100 and the preceding cart 100P. As shown in FIG. 7, the rear casters 110P of the preceding cart 100P and the rear casters 110 of the shopping cart 100 are lifted from the horizontal surface or ground G. This results in fewer casters on the ground, such as only the front casters 120P, 120 and 120S of the shopping carts 100P, 100, 100S and the rear casters 110S of shopping cart 100S. Thus, according to the invention, steering and transportation of a line of shopping carts nested together become much easier, especially when the rear casters are configured not to swivel. Although only three shopping carts are nested in FIG. 7, it should be understood that any number of shopping carts may be nested or concatenated together in order to move the group of shopping carts from one location, such as a parking lot to inside the store. In this case, only three shopping carts are shown for simplicity of description.

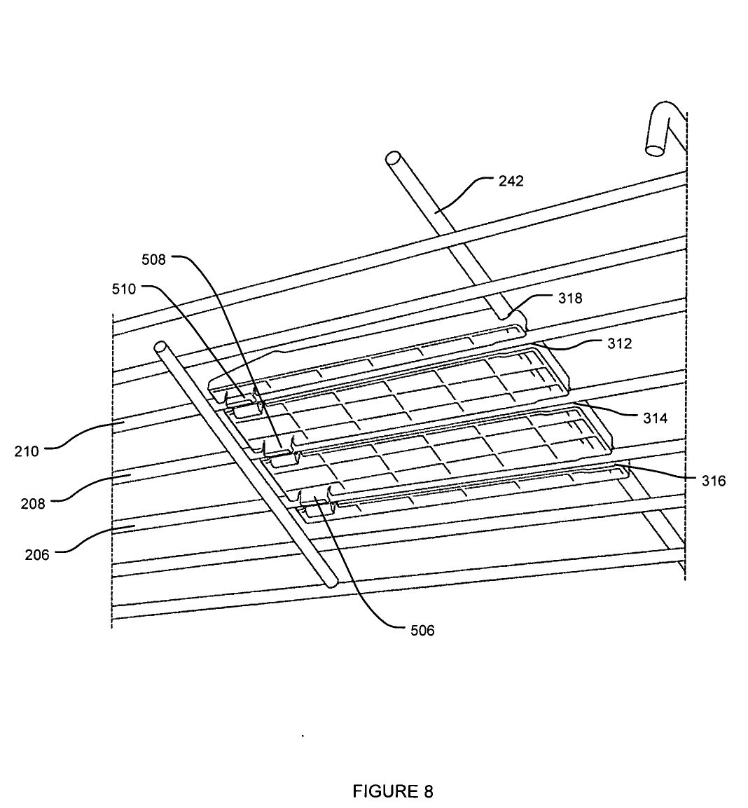

FIG. 8 shows an exemplary construction of the lifting structure 130 as seen from underneath the shopping cart 100. In particular, the lifting structure 130 is shown with longitudinal slots 316, 314 and 312 engaged to the longitudinal rods 206, 208 and 210 respectively, and a rear slot 318 engaged to the cross rod 242. The lifting structure 130 may further include engagement portions 506, 508, 510 that may snap fit to each of the longitudinal rods 206, 208 and 210 to provide a firm connection for the lifting structure 130 to the tray 106 and, in particular, the longitudinal rods 206, 208 and 210.

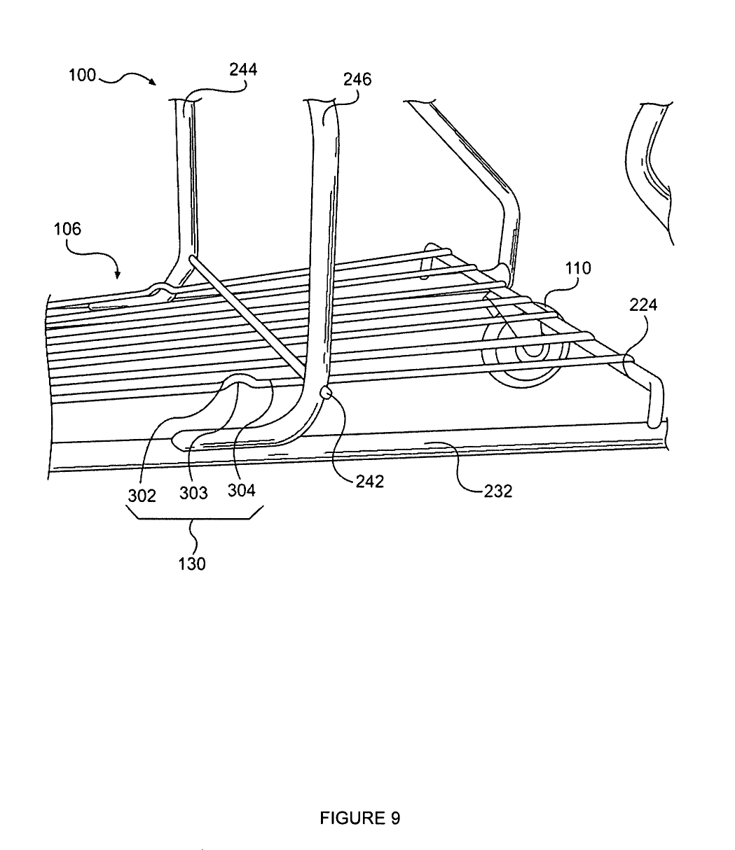

In the invention, the lifting structure 130 is contemplated as being molded from a material such as plastic, fiberglass, and the like. However, it is contemplated that the lifting structure 130 may also be integral with a plastic tray or formed with rods of a metallic tray as shown in FIG. 9. In such an implementation, the features of the lifting structure 130 would merely be molded in the tray or formed in the rod construction of the tray 106, providing the same lifting function as the separate lifting structure 130 and tray 106 described above. In this regard, FIG. 9 shows a ramp area 302, lip 303, and flat area 304 arranged as integral part of the tray 106. Moreover, the features of the caster lift 130 may be arranged in the shopping cart 100 without a tray 106. In such an implementation, a support structure may be employed to position the lift structure 130 in an operative position. The support structure may employ rods or any other known support structure.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A cart configured to be engaged with at least one other cart, comprising:
front and rear casters configured to allow rolling movement of the cart;
a frame supported by said front and rear casters;
a tray attached to said frame;
a lifting structure arranged with said tray and configured to elevate rear casters of a preceding cart upon engaging thereto.

2. The cart of claim 1, wherein said lifting structure comprises:
a first portion configured to elevate said rear casters of the at least one other cart upon engaging thereto; and
a second portion, adjoining said first portion, configured to maintain said rear casters of the at least one other cart to be elevated upon engaging thereto.

3. The cart of claim 2, wherein said lifting structure further comprises a third portion located between said first portion and said second portion and configured to resist the at least one other cart from sliding off the shopping cart.

4. The cart of claim 3, wherein the tray comprises:
a plurality of first rods extending between front and rear ends of said tray; and
at least one second rod traversing at least one of said first rods at a center portion of said tray.

5. The cart of claim 4, wherein said lifting structure is arranged on the center portion of said tray.

6. The cart of claim 5, wherein said lifting structure is formed of molded synthetic material.

7. The cart of claim 5, wherein said lifting structure further comprises:
a plurality of first slots configured to engage to said first rods; and
at last one second slot configured to engage to said at least one second rod.

8. The cart of claim 7, wherein said tray is formed of a molded synthetic material.

9. The cart of claim 4, wherein at least one of said first rods comprises said lifting structure.

10. The cart of claim 9, wherein said lifting structure of said at least one first rod comprises:
a first portion bent upward to elevate said rear casters of the preceding cart upon engaging thereto;
a second portion arranged with a predetermined distance from the ground to maintain said rear casters of the at least one other cart to be elevated upon engaging thereto;
a third portion arranged between said first and second portions and configured to resist the at least one other cart from sliding off the cart.

11. The cart of claim 10, said lifting structure is arranged at side portions of said tray.

12. The cart of claim 4, wherein said tray further comprises a cross bar arranged at the rear end of said tray and configured to engage a subsequent cart for elevating the rear casters of the cart.

13. The cart of claim 1, further comprising a basket attached to said frame and positioned above said tray.

14. The cart of claim 13, further comprising a handle arranged adjacent to a rear end of said basket.

15. The cart of claim 1, wherein said rear casters of the cart are configured not to swivel.

16. A lifting structure for a cart, comprising:
a ramp portion arranged on an upper surface of the lifting structure and configured to elevate rear casters of a preceding cart upon engaging thereto;
a lift portion arranged on said upper surface of the lifting structure and configured to maintain the rear casters of the preceding cart to be elevated upon engaging thereto; and
a lip portion arranged between said ramp portion and said lift portion on said upper surface of the lifting structure and configured to resist the preceding cart from sliding off the shopping cart.

17. The lifting structure of claim 16, further comprises an engagement unit configured to attach the lifting structure to a tray of the cart.

18. The lifting structure of claim 17, wherein said engagement unit comprises a plurality of first slots arranged on a bottom surface of said lifting structure and configured to engage said tray.

19. The lifting structure of claim 18, wherein said engagement unit further comprises at least one second slot arranged on said upper surface of said lifting structure and engage said tray.

20. The lifting structure of claim 16, wherein the lifting structure is formed of molded synthetic material.
